(19) United States
(12) Patent Application Publication
(10) Pub. No.: US 2023/0266481 A1
(43) Pub. Date: Aug. 24, 2023

(54) COMMUNICATION SYSTEM, SERVER DEVICE, AND COMMUNICATION DEVICE

(71) Applicant: SEIKO EPSON CORPORATION, Tokyo (JP)

(72) Inventors: Yasuhiro TERASHIMA, Matsumoto-shi (JP); Ryota Hirakawa, Shiojiri-shi (JP)

(73) Assignee: SEIKO EPSON CORPORATION, Tokyo (JP)

(21) Appl. No.: 18/171,377

(22) Filed: Feb. 20, 2023

(30) Foreign Application Priority Data
Feb. 21, 2022 (JP) 2022-024537

(51) Int. Cl. G01S 19/42; G01S 19/19

(52) U.S. Cl. CPC G01S 19/42; G01S 19/19

(57) ABSTRACT

A communication system includes a server device and a communication device worn by a player. The server device includes a route storage unit storing route information defining a set route and including height information associated with a position on the set route, a position acquisition unit that acquires an actual measurement position being a position actually measured from the communication device, and a position estimation unit that estimates an estimate position of the player on the set route based on the route information and the actual measurement position. The communication device includes a transmission unit that transmits the actual measurement position to the server device when a first distance between the estimate position and the actual measurement position is greater than or equal to an adjustment threshold value.

The present application is based on, and claims priority from JP Application Serial Number 2022-024537, filed Feb. 21, 2022, the disclosure of which is hereby incorporated by reference herein in its entirety.

### BACKGROUND

### 1. Technical Field

The present disclosure relates to a communication system, a server device, and a communication device.

### 2. Related Art

According to JP-A-2010-206253, a mobile phone capable of detecting a time and a travel distance is provided, a change prediction is calculated by being approximated by a linear equation based on an elapsed time and a result of a travel distance, and a time when there is a deviation out of a certain range from the change prediction point is used as a transmission timing to a server device.

However, the technology described in JP-A-2010-206253 cannot reduce the communication frequency between the communication device and the server device.

### SUMMARY

A communication system according to an aspect for solving the above problem includes a server device, and a communication device worn by a player competing in a competition involving moving along a set route, wherein the server device includes a route storage unit configured to store route information defining the set route and including height information associated with a position on the set route, a position acquisition unit configured to acquire an actual measurement position being a position actually measured from the communication device, and a position estimation unit configured to estimate a position of the player on the set route based on the route information and the actual measurement position and the communication device includes an estimate position acquisition unit configured to acquire, from the server device, an estimate position being an estimated position of the player, an actual measurement position acquisition unit configured to acquire the actual measurement position via a global navigation satellite system (GNSS), a first determination unit configured to determine whether a first distance between the estimate position and the actual measurement position is greater than or equal to a threshold value, and a transmission unit configured to transmit the actual measurement position to the server device when the first determination unit determines that the first distance is greater than or equal to the threshold value.

A server device according to another aspect for solving the above problem includes a route storage unit configured to store route information defining a set route and including height information associated with a position on the set route, a position acquisition unit configured to acquire an actual measurement position being a position actually measured from a communication device worn by a player competing in a competition involving moving along the set route, and a position estimation unit configured to estimate a position of the player on the set route based on the route information and the actual measurement position.

A communication device according to still another aspect for solving the above problem is a communication device worn by a player competing in a competition involving moving along a set route, the communication device including an estimate position acquisition unit configured to acquire, from a server device, an estimate position being an estimated position of the player, an actual measurement position acquisition unit configured to acquire an actual measurement position being a position actually measured of the player, a determination unit configured to determine whether a first distance between the estimate position and the actual measurement position is greater than or equal to a threshold value, and a transmission unit configured to transmit the actual measurement position to the server device when the determination unit determines that the first distance is greater than or equal to the threshold value.

### BRIEF DESCRIPTION OF THE DRAWINGS

FIG. 1 is a diagram illustrating an example of a configuration of a communication system according to an embodiment.

FIG. 2 is a diagram illustrating an example of configuration of a communication device according to the embodiment.

FIG. 3 is a diagram illustrating an example of a configuration of a server device according to the embodiment.

FIG. 4 is a graph showing an example of processing of a position estimation unit of the server device.

FIG. 5 is a diagram illustrating an example of processing of an adjustment unit of the communication device.

FIG. 6 is a flowchart illustrating an example of processing of a second control unit of the server device.

FIG. 7 is a flowchart illustrating an example of processing of a first control unit of the communication device.

FIG. 8 is a flowchart illustrating an example of threshold value setting processing of the first control unit of the communication device.

### DESCRIPTION OF EXEMPLARY EMBODIMENTS

An embodiment will be described below with reference to the drawings.

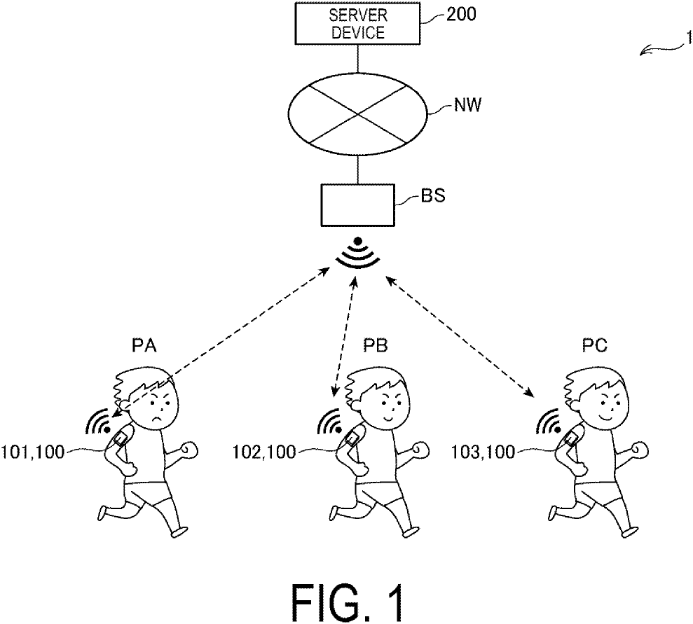

FIG. 1 is a diagram illustrating an example of a configuration of a communication system 1 according to the embodiment. The communication system 1 includes communication devices 100, a server device 200, and a wireless base station BS.

The communication devices 100 are communicably connected to the server device 200 via the wireless base station BS and a network NW. Each communication device 100 transmits an actual measurement position RP to the server device 200. The actual measurement position RP is a position of a player P that is actually measured. The communication device 100 acquires the actual measurement position RP via a global navigation satellite system (GNSS).

The communication devices 100 include, for example, a first communication device 101, a second communication device 102, and a third communication device 103. The first communication device 101, the second communication device 102, and the third communication device 103 have substantially the same configuration. Thus, the first communication device 101, the second communication device 102, and the third communication device 103 may be referred to as the communication device 100 when they are not distinguished from each other in the following description.

The first communication device 101 is worn by a first player PA, the second communication device 102 is worn by a second player PB, and the third communication device 103 is worn by a third player PC.

The first player PA, the second player PB, and the third player PC may be referred to as the player P when they are not distinguished from each other.

The first player PA, the second player PB, and the third player PC compete in a competition CP of moving along a preset route RT. The competition CP includes a first competition CP1 and a second competition CP2. The first competition CP1 is, for example, “run” in which the player P runs a long distance. The second competition CP2 is, for example, “bike” in which the player P rides on a bicycle.

The first communication device 101 corresponds to an example of the “communication device”.

The first player PA corresponds to an example of the “player”.

The server device 200 is communicably connected to the communication devices 100 via the network NW and the wireless base station BS. The server device 200 transmits an estimate position GP to each communication device 100. The estimate position GP is a position of the player P estimated by the server device 200.

The network NW is, for example, the Internet. The network NW may be a local area network (LAN) or a wide area network (WAN).

The network NW is connected to the wireless base station BS.

The wireless base station BS is connected in a wirelessly communicable manner to each of the first communication device 101, the second communication device 102, and the third communication device 103 in accordance with, for example, the Wi-Fi (trade name) standards.

The wireless base station BS includes, for example, a wireless router.

In the embodiment, a case is described in which the wireless base station BS and the communication devices 100 communicate with each other in accordance with the Wi-Fi standards, but the present disclosure is not limited thereto. The wireless base station BS and the communication devices 100 are only required to be connected in a wirelessly communicable manner. The wireless base station BS and the communication devices 100 may communicate with each other in accordance with, for example, the 3G standards, 4G standards, or 5G standards.

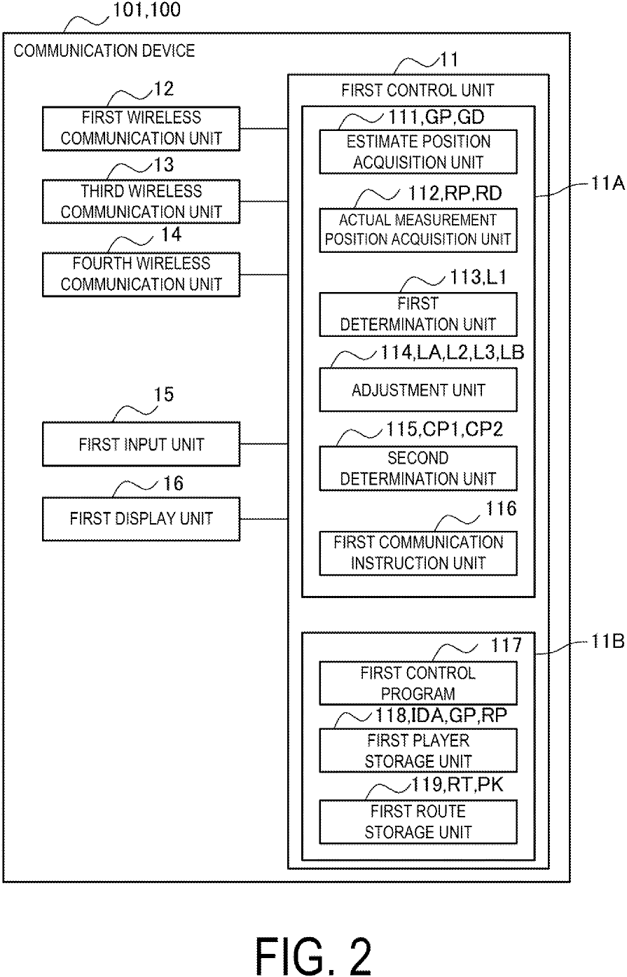

Next, a configuration of each communication device 100 will be described below with reference to FIG. 2. FIG. 2 is a diagram illustrating an example of the configuration of the communication device 100 according to the embodiment.

As illustrated in FIG. 2, the communication device 100 includes a first control unit 11, a first wireless communication unit 12, a third wireless communication unit 13, a fourth wireless communication unit 14, a first input unit 15, and a first display unit 16.

The first control unit 11 includes a first processor 11A such as a central processing unit (CPU) or a micro-processing unit (MPU) and a first memory 11B such as a read-only memory (ROM) or a random-access memory (RAM), and controls each unit of the communication device 100. The first memory 11B includes a storage device such as a hard disk drive (HDD) or a solid-state drive (SSD).

The first memory 11B stores a first control program 117.

The first wireless communication unit 12 includes a wireless communication circuit compliant with, for example, the Wi-Fi standards and is connected, under an instruction from the first control unit 11, to the server device 200 via the wireless base station BS and the network NW in a wirelessly communicable manner in accordance with the Wi-Fi standards.

The third wireless communication unit 13 acquires the actual measurement position RP via the GNSS according to an instruction from the first control unit 11. The third wireless communication unit 13 acquires the actual measurement position RP by, for example, receiving radio waves from the GNSS according to the instruction from the first control unit 11. The actual measurement position RP includes, for example, a latitude and a longitude.

The fourth wireless communication unit 14 includes a wireless communication circuit compliant with, for example, the Bluetooth standard and is connected, under an instruction from the first control unit 11, to the other communication devices 100 in a wirelessly communicable manner in accordance with the Bluetooth standard.

In the embodiment, a case is described in which the fourth wireless communication unit 14 is connected to the other communication devices 100 in a wirelessly communicable manner in accordance with the Bluetooth standard, but the present disclosure is not limited thereto. The fourth wireless communication unit 14 is only required to be connected to the other communication devices 100 in a wirelessly communicable manner in accordance with a near-field wireless communication standard. The fourth wireless communication unit 14 may be connected to the other communication devices 100 in a wirelessly communicable manner in accordance with, for example, the ZigBee standard.

The first input unit 15 includes an input mechanism such as a touch pad provided at the communication device 100, detects an operation from a user on the input mechanism, and outputs an operation signal corresponding to the operation to the first control unit 11. The first control unit 11 executes processing corresponding to the user operation based on the input from the first input unit 15.

The first display unit 16 includes, for example, a liquid crystal display (LCD) and displays, on the LCD, various images such as the order of the players P wearing the communication devices 100 in accordance with control of the first control unit 11.

Next, function units of the first control unit 11 of the communication device 100 will be described. Note that, in the following description, the first communication device 101 will be described as an example of the communication device 100.

The first control unit 11 includes, as function units, an estimate position acquisition unit 111, an actual measurement position acquisition unit 112, a first determination unit 113, an adjustment unit 114, a second determination unit 115, a first communication instruction unit 116, a first player storage unit 118, and a first route storage unit 119.

Specifically, the first processor 11A executes the first control program 117 stored in the first memory 11B, thereby functioning as the estimate position acquisition unit 111, the actual measurement position acquisition unit 112, the first determination unit 113, the adjustment unit 114, the second determination unit 115, and the first communication instruction unit 116. The first processor 11A executes the first control program 117 stored in the first memory 11B, thereby causing the first memory 11B to function as the first player storage unit 118 and the first route storage unit 119.

The first control unit 11 can include, for example, an integrated circuit. The integrated circuit includes an LSI, an application specific integrated circuit (ASIC), and a programmable logic device (PLD). The PLD includes, for example, a field programmable gate array (FPGA). Furthermore, the first control unit 11 may include an analog circuit in a part of the configuration of the integrated circuit, or may be a combination of a processor and an integrated circuit. The combination of a processor and an integrated circuit is called a microcontroller (MCU), a system-on-a-chip (SoC), a system LSI, a chipset, or the like.

The first player storage unit 118 stores first identification information IDA of the first player PA wearing the first communication device 101. The first identification information IDA is information for identifying the first player PA. The first player storage unit 118 also stores the estimate position GP, an estimate date and time GD, the actual measurement position RP, and the actual measurement date and time RD. The estimate position GP is acquired by the estimate position acquisition unit 111 and stored in the first player storage unit 118. The actual measurement position RP is acquired by the actual measurement position acquisition unit 112 and stored in the first player storage unit 118.

The first route storage unit 119 stores route information defining the set route RT and including height information associated with a position on the route RT. The route RT is, for example, set in advance and stored in the first route storage unit 119. The route RT is a path along which each player P moves while competing in the competition CP. The route information includes information indicating a competition change position PK, which is a position where the competition CP changes from the first competition CP1 to the second competition CP2.

In the embodiment, a case is described in which the route RT is set in advance, but the present disclosure is not limited thereto. For example, the route RT may be set by communication equipment mounted on a vehicle or the like leading the players P. The communication equipment may acquire position information of the route RT from the GNSS and set the route RT.

The estimate position acquisition unit 111 acquires the estimate position GP and the estimate date and time GD from the server device 200 via the first wireless communication unit 12. The estimate position GP is a position of the first player PA on the route RT estimated by the server device 200. The estimate position acquisition unit 111 stores the estimate position GP in the first player storage unit 118 in association with the estimate date and time GD. The estimate date and time GD is a date and time when the first player PA arrives at the estimate position GP.

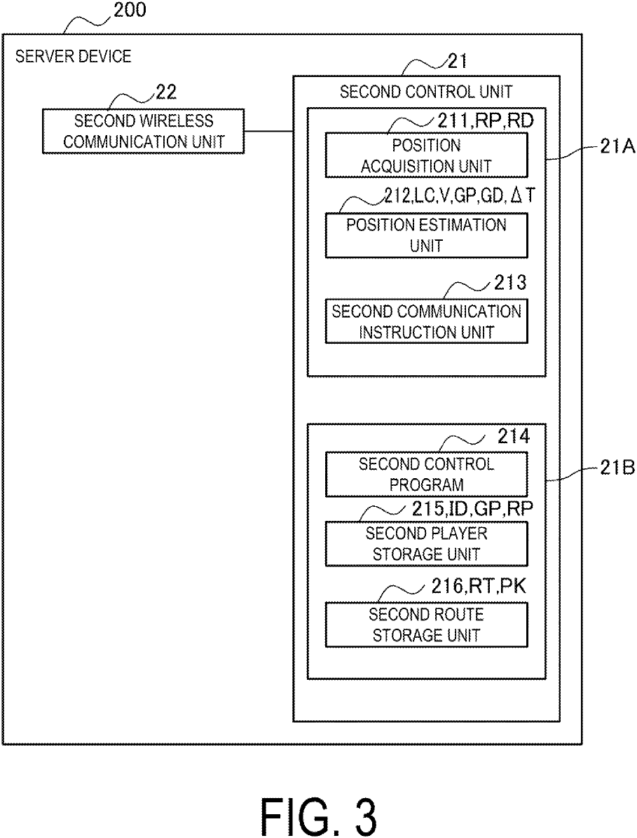

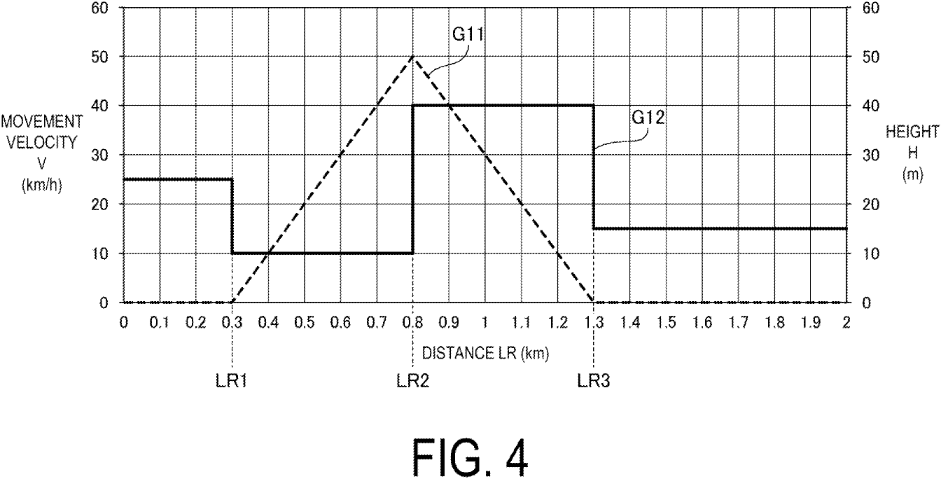

The estimate position GP will be further described with reference to FIGS. 3 and 4.

The actual measurement position acquisition unit 112 acquires the actual measurement position RP and the actual measurement date and time RD from the GNSS via the third wireless communication unit 13. The actual measurement position acquisition unit 112 stores the actual measurement position RP in the first player storage unit 118 in association with the actual measurement date and time RD. The actual measurement date and time RD is a date and time when the actual measurement position RP is measured by the GNSS.

The first determination unit 113 determines whether a first distance L1 between the estimate position GP and the actual measurement position RP is greater than or equal to an adjustment threshold value LA. The first distance L1 is, for example, a distance between the estimate position GP and the actual measurement position RP along the route RT. The route RT is a path along which each player P moves during the competition.

The first determination unit 113 reads, from the first player storage unit 118, the estimate position GP corresponding to the same date and time as the actual measurement date and time RD, for example, when the actual measurement position acquisition unit 112 acquires the actual measurement position RP and the actual measurement date and time RD. In other words, the first determination unit 113 reads, from the first player storage unit 118, the estimate position GP corresponding to the estimate date and time GD that is the same as the actual measurement date and time RD. Then, the first determination unit 113 calculates the first distance L1 between the read estimate position GP and the actual measurement position RP along the route RT and determines whether the first distance L1 is greater than or equal to the adjustment threshold value LA.

The first determination unit 113 determines whether the estimate position GP to be compared with the actual measurement position RP is stored in the first player storage unit 118. For example, the first determination unit 113 determines that the estimate position GP to be compared with the actual measurement position RP is not stored in the first player storage unit 118 when the last date and time among the estimate dates and times GD stored in the first player storage unit 118 is before the date and time when the actual measurement position RP is acquired, that is, the actual measurement date and time RD.

The second determination unit 115 determines whether the first player PA is competing in the first competition CP1 or the second competition CP2. Note that the competition change position PK, which is a position where the competition CP changes from the first competition CP1 to the second competition CP2, is preset on the route RT.

For example, when the actual measurement position RP of the first player PA is located in the direction of movement of the players P relative to the competition change position PK, the second determination unit 115 determines that the first player PA is competing in the second competition CP2. Further, for example, when the actual measurement position RP of the first player PA is located in the direction opposite to the direction of movement of the players P relative to the competition change position PK, the second determination unit 115 determines that the first player PA is competing in the first competition CP1.

The adjustment unit 114 adjusts the adjustment threshold value LA in accordance with the second distance L2 between the first player PA wearing the first communication device 101 and each of the other players. For example, the adjustment threshold value LA is increased as the second distance L2 becomes larger. For example, when the second distance L2 is 10 m or less, the adjustment unit 114 sets the adjustment threshold value LA to 10 m. Further, for example, when the second distance L2 is greater than 10 m and 30 m or less, the adjustment unit 114 sets the adjustment threshold value LA to 20 m. For example, when the second distance L2 is greater than 30 m, the adjustment unit 114 sets the adjustment threshold value LA to 30 m.

The adjustment threshold value LA corresponds to an example of the “threshold value”.

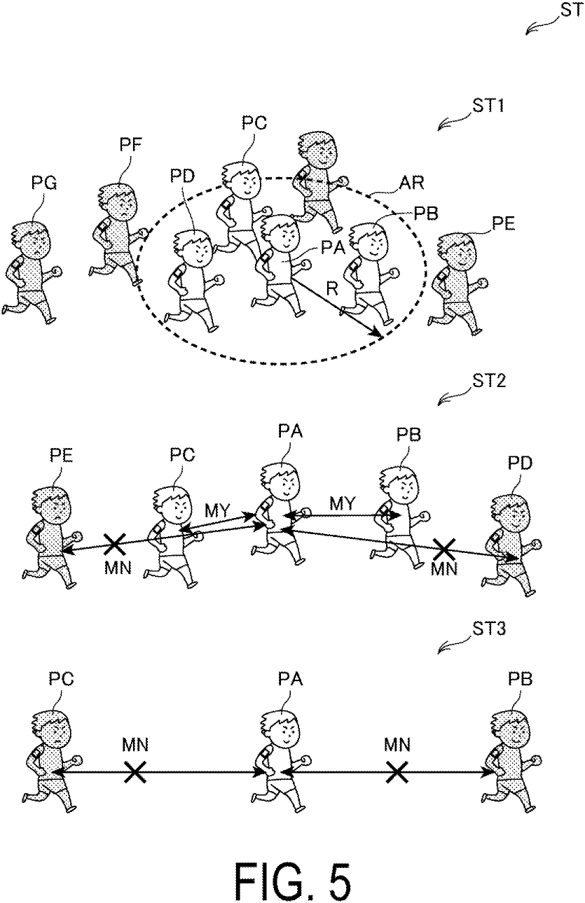

The second distance L2 will be further described with reference to FIG. 5.

The adjustment unit 114 also adjusts the adjustment threshold value LA in accordance with the determination result of the second determination unit 115. The first competition CP1 is, for example, “run”, and the second competition CP2 is, for example, “bike”. In this case, the movement velocity of the first player PA at the time of competing in the second competition CP2 is higher than the movement velocity of the first player PA at the time of competing in the first competition CP1. Thus, for example, when the second determination unit 115 determines that the first player PA is competing in the second competition CP2, the adjustment unit 114 increases the adjustment threshold value LA as compared to a case where the second determination unit 115 determines that the first player PA is competing in the first competition CP1.

For example, when the second determination unit 115 determines that the first player PA is competing in the first competition CP1, the adjustment unit 114 sets the adjustment threshold value LA to 20 m. When the second determination unit 115 determines that the first player PA is competing in the second competition CP2, the adjustment unit 114 sets the adjustment threshold value LA to 50 m.

Additionally, when a third distance L3 between the first player PA and the competition change position PK, which is a position where the competition CP changes from the first competition CP1 to the second competition CP2, is less than or equal to a distance threshold value LB, the adjustment unit 114 adjusts the adjustment threshold value LA from a first adjustment threshold value LA1 to a second adjustment threshold value LA2 smaller than the first adjustment threshold value LA1. The distance threshold value LB is, for example, 20 m. The first adjustment threshold value LA1 is, for example, 20 m, and the second adjustment threshold value LA2 is, for example, 10 m.

The first adjustment threshold value LA1 corresponds to an example of the “first threshold value”.

The second adjustment threshold value LA2 corresponds to an example of the “second threshold value”.

When the first determination unit 113 determines that the first distance L1 is greater than or equal to the adjustment threshold value LA, or when the first determination unit 113 determines that the estimate position GP to be compared with the actual measurement position RP is not stored in the first player storage unit 118, the first communication instruction unit 116 executes the following processing.

In other words, the first communication instruction unit 116 causes the actual measurement position acquisition unit 112 to acquire the actual measurement position RP and the actual measurement date and time RD from the GNSS via the third wireless communication unit 13. Then, the first communication instruction unit 116 associates the acquired actual measurement position RP and actual measurement date and time RD with the first identification information IDA and transmits them to the server device 200 via the first wireless communication unit 12.

Furthermore, the first communication instruction unit 116 causes the estimate position acquisition unit 111 to acquire the estimate position GP and the estimate date and time GD from the server device 200 via the first communication device 101.

The first communication instruction unit 116 corresponds to an example of the “transmission unit”.

As described with reference to FIG. 2, the adjustment unit 114 adjusts the adjustment threshold value LA in accordance with the second distance L2 between the first player PA wearing the first communication device 101 and each of the other players, the determination result of the second determination unit 115, and whether the third distance L3 is less than or equal to the distance threshold value LB. Thus, the adjustment threshold value LA can be appropriately adjusted.

In the embodiment, a case is described in which the adjustment unit 114 adjusts the adjustment threshold value LA in accordance with the second distance L2, the determination result of the second determination unit 115, and whether the third distance L3 is less than or equal to the distance threshold value LB, but the present disclosure is not limited thereto. The adjustment unit 114 is only required to adjust the adjustment threshold value LA in accordance with at least one of the second distance L2, the determination result of the second determination unit 115, or whether the third distance L3 is less than or equal to the distance threshold value LB. For example, the adjustment unit 114 may adjust the adjustment threshold value LA in accordance with the determination result of the second determination unit 115. In this case, the processing of the adjustment unit 114 can be simplified.

Next, a configuration of the server device 200 will be described with reference to FIG. 3. FIG. 3 is a diagram illustrating the configuration example of the server device 200 according to the embodiment.

As illustrated in FIG. 3, the server device 200 includes a second control unit 21 and a second wireless communication unit 22.

The second control unit 21 includes a second processor 21A such as a CPU or an MPU and a second memory 21B such as a ROM or a RAM and controls each unit of the server device 200. The second memory 21B also includes a storage device such as an HDD or an SSD.

The second memory 21B stores a second control program 214.

The second wireless communication unit 22 includes a communication circuit compliant with the Ethernet (trade name) standards and is communicably connected, under an instruction from the second control unit 21, to the wireless base station BS via the network NW in accordance with the Ethernet standards.

Next, function units of the second control unit 21 of the server device 200 will be described.

The second control unit 21 includes, as function units, a position acquisition unit 211, a position estimation unit 212, a second communication instruction unit 213, a second player storage unit 215, and a second route storage unit 216. Specifically, the second processor 21A executes the second control program 214 stored in the second memory 21B, thereby functioning as the position acquisition unit 211, the position estimation unit 212, and the second communication instruction unit 213. The second processor 21A executes the second control program 214 stored in the second memory 21B, thereby causing the second memory 21B to function as the second player storage unit 215 and the second route storage unit 216.

The second player storage unit 215 stores the estimate position GP, the estimate date and time GD, the actual measurement position RP, and the actual measurement date and time RD in association with the identification information ID of each player P. The estimate position GP is estimated by the position estimation unit 212 and stored in the second player storage unit 215 in association with the estimate date and time GD. The actual measurement position RP is acquired by the position acquisition unit 211 and stored in the second player storage unit 215 in association with the actual measurement date and time RD.

The second route storage unit 216 stores route information defining the preset route RT and including height information associated with a position on the route RT. The route RT is a path along which each player P moves while competing in the competition CP. The route information includes information indicating the competition change position PK, which is a position where the competition CP changes from the first competition CP1 to the second competition CP2.

The position acquisition unit 211 acquires the actual measurement position RP from the communication device 100 via the second wireless communication unit 22. For example, the position acquisition unit 211 acquires the actual measurement position RP and the actual measurement date and time RD in association with the identification information ID from the communication device 100 via the second wireless communication unit 22. The identification information ID is information for identifying each player P. In other words, the identification information ID is information for identifying the communication device 100 worn by each player P.

The position acquisition unit 211 stores the acquired actual measurement position RP and actual measurement date and time RD in the second player storage unit 215 in association with the identification information ID.

The position estimation unit 212 estimates the movement velocity V of the player P and a position on the route RT based on the route information and the actual measurement position RP. The position of the player P on the route RT estimated by the position estimation unit 212 is described as an estimate position GP. The position estimation unit 212 estimates the movement velocity V and the position on the route RT of the player P corresponding to the identification information ID, for example, when the position acquisition unit 211 acquires, from the communication device 100, the actual measurement position RP in association with the identification information ID.

The position estimation unit 212 estimates, for example, the movement velocity V from the actual measurement position RP to a position at a predetermined distance LC from the actual measurement position RP along the route RT in the direction of movement of the player P. The predetermined distance LC is, for example, 2 km.

Additionally, the position estimation unit 212 estimates, based on the movement velocity V, a position of the player P on the route RT for each unit time ΔT, that is, the estimate position GP at the estimate date and time GD for each unit time ΔT. The unit time ΔT is, for example, 5 seconds.

The position acquisition unit 211 stores the estimate positions GP and the estimate dates and times GD in the second player storage unit 215 in association with the identification information ID of the player P.

The position estimation unit 212 and the movement velocity V will be further described with reference to FIG. 4.

In the embodiment, a case is described in which the predetermined distance LC is 2 km and the unit time ΔT is 5 seconds, but the present disclosure is not limited thereto. The predetermined distance LC and the unit time ΔT may be set in accordance with the competition CP in which the player P is competing.

For example, when the player P is competing in the first competition CP1, that is, “run”, the predetermined distance LC is set to 2 km, and the unit time ΔT is set to 5 seconds. For example, when the player P is competing in the second competition CP2, that is, “bike”, the predetermined distance LC is set to 5 km, and the unit time ΔT is set to 2 seconds.

When competing in the second competition CP2, the movement velocity V of the player P is higher than when competing in the first competition CP1. Thus, when competing in the second competition CP2, the predetermined distance LC may be set to be longer and the unit time ΔT may be set to be shorter than when competing in the first competition CP1.

The second communication instruction unit 213 causes the second wireless communication unit 22 to acquire, from the communication device 100, the actual measurement position RP and the actual measurement date and time RD in association with the identification information ID.

Additionally, the second communication instruction unit 213 causes the second wireless communication unit 22 to transmit, to the communication device 100 corresponding to the identification information ID, the estimate positions GP and the estimate dates and times GD in association with the identification information ID when the position estimation unit 212 estimates the estimate positions GP. Note that the communication device 100 corresponding to the identification information ID is the communication device 100 worn by the player P corresponding to the identification information ID.

Next, an example of processing of the position estimation unit 212 of the server device 200 will be described with reference to FIG. 4. FIG. 4 is a graph showing an example of the position estimation unit 212 of the server device 200. The horizontal axis of the graph represents the distance LR along the route RT from the point where the movement velocity V is started to be estimated. The right vertical axis of the graph represents the height H, and the left vertical axis of the graph represents the movement velocity V of the player P estimated by the position estimation unit 212. Note that the height H is, for example, a height when the height H at the point where the movement velocity V is started to be estimated is set to zero.

A graph G11 shows a change in the height H corresponding to the distance LR. A graph G12 shows a change in the movement velocity V corresponding to the distance LR.

As shown by the graph G11, the height H is zero while the distance LR is from zero to the distance LR1. The distance LR1 is 0.3 km. While the distance LR is from the distance LR1 to the distance LR2, there is an upward slope having a fixed inclination. As to the inclination of the upward slope, the height H increases by 10 m while the distance LR increases by 0.1 km. The distance LR2 is 0.8 km. While the distance LR is from the distance LR2 to the distance LR3, there is a downward slope having a fixed inclination. As to the inclination of the downward slope, the height H decreases by 10 m while the distance LR increases by 0.1 km. The distance LR3 is 1.3 km. The height H is zero while the distance LR is from the distance LR3 to 2 km.

While the distance LR is from zero to the distance LR3, the position estimation unit 212 estimates the movement velocity V by Equation (1) below. V = Vc + α × ΔH (1)

Here, the velocity Vc is the movement velocity V of the player P in a flat course. The velocity Vc is, for example, 25 km/h. That is, the movement velocity V is 25 km/h while the distance LR is from zero to the distance LR1 as shown by the graph G12. The inclination ΔH is determined by Equation (2) below. ΔH = H1 - H2 (2)

The height H1 is the height H at the point where the movement velocity V is calculated. The height H2 is the height H at the point at 100 m from the point where the movement velocity V is calculated in the direction of movement of the player P. For example, while the distance LR is from the distance LR1 to the distance LR2, the inclination ΔH is -10 m. In addition, for example, while the distance LR is from the distance LR2 to the distance LR3, the inclination ΔH is 10 m.

The coefficient α is a coefficient for correcting the movement velocity V with respect to the inclination ΔH. The coefficient α is, for example, 1.5. In this case, the movement velocity V while the distance LR is from the distance LR1 to the distance LR2 is 10 (= 25 + 1.5 × (-10)) km/h, as shown by the graph G12. Also, the movement velocity V while the distance LR is from the distance LR2 to the distance LR3 is 40 (= 25 + 1.5 × (10)) km/h.

While the distance LR is from the distance LR3 to 2 km, the position estimation unit 212 estimates the movement velocity V by Equation (3) below. V = Vc + α × ΔH - Vt (3)

The correction velocity Vt indicates a decrease in the movement velocity V due to the running of the player P on the upward hill from the distance LR1 to the distance LR2 and on the downward hill from the distance LR2 to the distance LR3. The correction velocity Vt is, for example, 10 km/h. In this case, the movement velocity V while the distance LR is from the distance LR3 to 2 km is 15 (= 25 - 10) km/h, as shown by the graph G12.

As described with reference to FIG. 4, the position estimation unit 212 increases or decreases the movement velocity V in accordance with the inclination ΔH of the route RT as in Equation (1) and Equation (3), and thus can appropriately calculate the movement velocity V. In addition, as in Equation (3), the position estimation unit 212 calculates the movement velocity V so as to reflect the decrease in the movement velocity V due to the running of the player P on the upward slope and on the downward slope, and thus can appropriately calculate the movement velocity V.

Next, an example of processing of the adjustment unit 114 of the communication device 100 will be described with reference to FIG. 5. FIG. 5 is an explanatory diagram ST illustrating an example of processing of the adjustment unit 114 of the communication device 100.

The explanatory diagram ST is a diagram for describing a method of threshold value adjustment processing by the adjustment unit 114. The threshold value adjustment processing is processing for adjusting the adjustment threshold value LA in accordance with the second distance L2 between the first player PA wearing the first communication device 101 and each of the other players. The threshold value adjustment processing includes first adjustment processing and second adjustment processing.

The explanatory diagram ST includes a first explanatory diagram ST1 for describing the first adjustment processing, and a second explanatory diagram ST2 and a third explanatory diagram ST3 for describing the second adjustment processing.

First, the first adjustment processing will be described with reference to the first explanatory diagram ST1.

In the first adjustment processing, the adjustment unit 114 determines whether the distance between the first player PA and each of the other players PB to PG is less than or equal to a distance R. A range AR is a range where the distance from the first player PA is less than or equal to the distance R. The distance R is, for example, 50 m. The adjustment unit 114 acquires, via the fourth wireless communication unit 14, the actual measurement position RP from the communication device 100 worn by each of the other players PB to PG. Note that in the first explanatory diagram ST1, the first communication device 101 worn by the first player PA and the communication device 100 worn by each of the other players PB to PG simultaneously acquire the actual measurement positions RP from the GNSS.

The adjustment unit 114 determines whether the distance between the first player PA and each of the other players PB to PG is less than or equal to the distance R based on the actual measurement position RP of the first player PA and the actual measurement position RP of each of the other players PB to PG.

As illustrated in the first explanatory diagram ST1, for example, the other players PB, PC, and PD are located within the range AR. That is, the adjustment unit 114 determines that the distance between the actual measurement position RP of the first player PA and the actual measurement position RP of each of the other players PB to PD is less than or equal to the distance R.

As illustrated in the first explanatory diagram ST1, for example, the other players PE, PF, and PG are located outside the range AR. That is, the adjustment unit 114 determines that the distance between the actual measurement position RP of the first player PA and the actual measurement position RP of each of the other players PE to PG is not less than or equal to the distance R.

In this manner, the adjustment unit 114 sets the adjustment threshold value LA to 20 m because the plurality of other players P (here, three) are located inside the range AR. Note that, for example, when one of the other players P is located inside the range AR, the adjustment threshold value LA is set to 50 m. In addition, when none of the other players P is located inside the range AR, the adjustment threshold value LA is set to 70 m.

As described with reference to the first explanatory diagram ST1, the adjustment unit 114 adjusts the adjustment threshold value LA in accordance with the number of the other players P located inside the range AR and thus can set the adjustment threshold value LA to an appropriate value.

Note that in the embodiment, a case has been described in which the adjustment unit 114 adjusts the adjustment threshold value LA in accordance with the number of the other players P located inside the range AR, but the present disclosure is not limited thereto. The adjustment unit 114 may adjust the adjustment threshold value LA in accordance with the distance between the first player PA and the other player PB closest to the first player PA. For example, the adjustment unit 114 may adjust the adjustment threshold value LA to a value less than or equal to the distance between the first player PA and the other player PB closest to the first player PA.

Next, the second adjustment processing will be described with reference to the second explanatory diagram ST2 and the third explanatory diagram ST3.

In the second adjustment processing, the adjustment unit 114 determines whether the first communication device 101 worn by the first player PA can communicate with the communication device 100 worn by each of the other players PB to PG via the fourth wireless communication unit 14. In the second explanatory diagram ST2 and the third explanatory diagram ST3, a two-directional arrow MY indicates that communication is possible, and an X mark MN indicates that communication is impossible. The communicable distance of the fourth wireless communication unit 14 is, for example, 30 m.

In the second explanatory diagram ST2, the adjustment unit 114 determines that the first communication device 101 worn by the first player PA can communicate with the communication device 100 worn by each of the other players PB to PC. Additionally, the adjustment unit 114 determines that the first communication device 101 worn by the first player PA cannot communicate with the communication device 100 worn by each of the other players PD and PE.

Additionally, in the third explanatory diagram ST3, the adjustment unit 114 determines that the first communication device 101 worn by the first player PA cannot communicate with the communication device 100 worn by each of the other players PB and PC. That is, in the third explanatory diagram ST3, the adjustment unit 114 determines that none of the communication devices 100 worn by the other players P can communicate with the first communication device 101 worn by the first player PA.

In the state illustrated in the second explanatory diagram ST2, the adjustment unit 114 sets the adjustment threshold value LA to a value smaller than the communicable distance of the fourth wireless communication unit 14, e.g., 20 m. In the state illustrated in the third explanatory diagram ST3, the adjustment unit 114 sets the adjustment threshold value LA to a value greater than or equal to the communicable distance of the fourth wireless communication unit 14, e.g., 40 m.

As described with reference to the second explanatory diagram ST2 and the third explanatory diagram ST3, the adjustment unit 114 adjusts the adjustment threshold value LA in accordance with whether communication is possible with the communication device 100 worn by each of the other players P via the fourth wireless communication unit 14, and thus can easily adjust the adjustment threshold value LA.

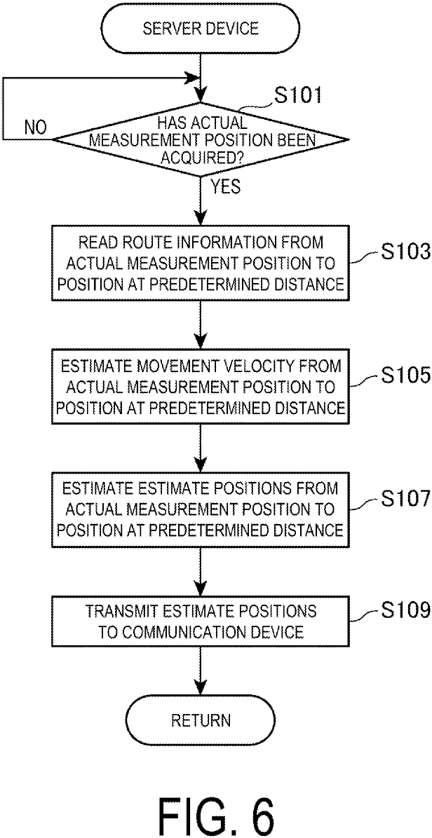

Next, processing of the second control unit 21 of the server device 200 will be described with reference to FIG. 6. FIG. 6 is a flowchart illustrating an example of the processing of the second control unit 21 of the server device 200.

As illustrated in FIG. 6, in step S101, the position acquisition unit 211 first determines whether the actual measurement position RP has been acquired from the communication device 100 via the second wireless communication unit 22.

When the position acquisition unit 211 determines that the actual measurement position RP has not been acquired from the communication device 100 (NO in step S101), the processing proceeds to a standby state. When the position acquisition unit 211 determines that the actual measurement position RP has been acquired from the communication device 100 (YES in step S101), the processing proceeds to step S103.

Then, in step S103, the position estimation unit 212 reads, from the second route storage unit 216, route information from the actual measurement position RP to a position at the predetermined distance LC from the actual measurement position RP along the route RT in the direction of movement of the player P.

Next, in step S105, the position estimation unit 212 estimates, based on the route information read in step S103, the movement velocity V from the actual measurement position RP to the position at the predetermined distance LC from the actual measurement position RP along the route RT in the direction of movement of the player P.

Next, in step S107, the position estimation unit 212 estimates, based on the movement velocity V estimated in step S105, the estimate positions GP from the actual measurement position RP to the position at the predetermined distance LC from the actual measurement position RP along the route RT in the direction of movement of the player P. In addition, the position estimation unit 212 stores the estimate positions GP in the second player storage unit 215 in association with the identification information ID of the communication device 100 the actual measurement position RP of which has been acquired in step S101.

Next, in step S109, the second communication instruction unit 213 transmits the estimate positions GP estimated in step S107 to the communication device 100 the actual measurement position RP of which has been acquired in step S101. The processing then returns to step S101.

As described with reference to FIG. 6, the position estimation unit 212 estimates the estimate positions GP from the actual measurement position RP to the position at the predetermined distance LC from the actual measurement position RP along the route RT in the direction of movement of the player P. Thus, by setting the predetermined distance LC to an appropriate distance, the frequency of transmission of the actual measurement position RP from the communication device 100 to the server device 200 can be reduced while the estimation accuracy maintained.

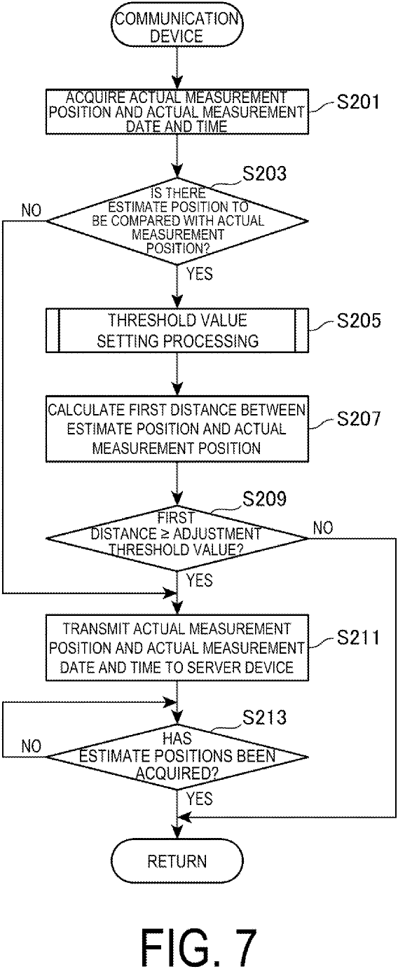

Next, processing of the first control unit 11 of the communication device 100 will be described with reference to FIG. 7. FIG. 7 is a flowchart illustrating an example of the processing of the first control unit 11 of the communication device 100.

Note that in FIG. 7, a case is described in which the estimate position acquisition unit 111 acquires the estimate positions GP in advance from the server device 200.

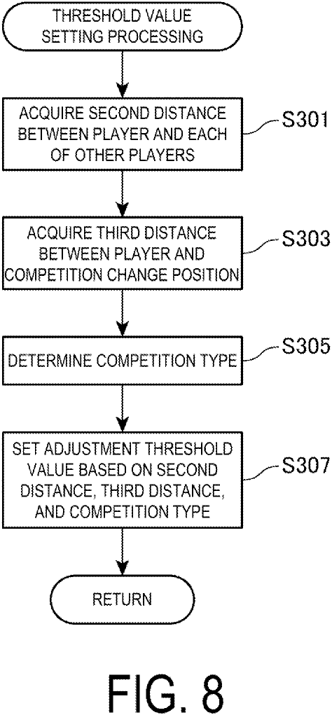

For example, when starting the first competition CP1, the player P inputs a start operation, which is an operation indicating start of the first competition CP1, to the first input unit 15 of the communication device 100 worn by the player P. When receiving the start operation, the first control unit 11 acquires the actual measurement position RP and the actual measurement date and time RD from the GNSS. The first control unit 11 transmits the actual measurement position RP and the actual measurement date and time RD to the server device 200. The first control unit 11 receives the estimate positions GP from the server device 200 and stores the estimate positions GP in the first player storage unit 118. Further, in FIGS. 7 and 8, a case is described in which the communication device 100 is the first communication device 101.

First, in step S201, the actual measurement position acquisition unit 112 acquires the actual measurement position RP and the actual measurement date and time RD from the GNSS via the third wireless communication unit 13.

Next, in step S203, the first determination unit 113 determines whether there is an estimate position GP to be compared with the actual measurement position RP acquired in step S201. The estimate position GP to be compared with the actual measurement position RP is an estimate position GP corresponding to the actual measurement date and time RD. In other words, the first determination unit 113 determines whether the estimate position GP to be compared with the actual measurement position RP is stored in the first player storage unit 118.

When the estimate position acquisition unit 111 determines that there is no estimate position GP to be compared with the actual measurement position RP (NO in step S203), the processing proceeds to step S211. When the estimate position acquisition unit 111 determines that the estimate position GP to be compared with the actual measurement position RP is present (YES in step S203), the processing proceeds to step S205.

Then, in step S205, the first control unit 11 executes the “threshold value setting processing”. The “threshold value setting processing” is processing for setting the adjustment threshold value LA.

Next, in step S207, the first determination unit 113 calculates the first distance L1 between the estimate position GP and the actual measurement position RP along the route RT.

Next, in step S209, the first determination unit 113 determines whether the first distance L1 calculated in step S207 is greater than or equal to the adjustment threshold value LA set in step S205.

When the first determination unit 113 determines that the first distance L1 is not greater than or equal to the adjustment threshold value LA (NO in step S209), the processing returns to step S201. When the first determination unit 113 determines that the first distance L1 is greater than or equal to the adjustment threshold value LA (YES in step S209), the processing proceeds to step S211.

Then, in step S211, the first communication instruction unit 116 associates the actual measurement position RP and the actual measurement date and time RD with the identification information ID, which is the identification information of the player P, and transmits them to the server device 200 via the first wireless communication unit 12.

Next, in step S213, the estimate position acquisition unit 111 determines whether the estimate positions GP and the estimate dates and times GD have been acquired from the server device 200 via the first communication device 101.

When the estimate position acquisition unit 111 determines that the estimate positions GP and the estimate dates and times GD have not been acquired (NO in step S213), the processing proceeds to a standby state. When the estimate position acquisition unit 111 determines that the estimate positions GP and the estimate dates and times GD have been acquired (YES in step S213), the estimate position acquisition unit 111 stores the acquired estimate positions GP and estimate dates and times GD in the first player storage unit 118. The processing then returns to step S201.

As described with reference to FIG. 7, when the first determination unit 113 determines that the estimate position GP to be compared with the actual measurement position RP is not stored in the first player storage unit 118, the following processing is performed. That is, the first communication instruction unit 116 causes the actual measurement position acquisition unit 112 to acquire the actual measurement position RP from the GNSS, transmits the actual measurement position RP to the server device 200, and causes the estimate position acquisition unit 111 to acquire the estimate positions GP from the server device 200.

In this manner, the estimate positions GP are acquired from the server device 200 when the first determination unit 113 determines that the estimate position GP to be compared with the actual measurement position RP is not stored in the first player storage unit 118. Thus, the frequency of communication between the communication device 100 and the server device 200 can be reduced.

Next, the threshold value setting processing of the first control unit 11 of the communication device 100 will be described with reference to FIG. 8. FIG. 8 is a flowchart illustrating an example of the threshold value setting processing of the first control unit 11 of the communication device 100.

First, in step S301, the adjustment unit 114 acquires the second distance L2 between the first player PA wearing the first communication device 101 and each of the other players P.

Next, in step S303, the adjustment unit 114 acquires the third distance L3 between the competition change position PK and the first player PA.

Next, in step S305, the second determination unit 115 determines the competition type in which the first player PA is competing. That is, the second determination unit 115 determines whether the first player PA is competing in the first competition CP1 or the second competition CP2.

Next, in step S307, the adjustment unit 114 sets the adjustment threshold value LA based on the second distance L2, the third distance L3, and the competition type. The processing then returns to step S207 in FIG. 7.

As described with reference to FIG. 8, the adjustment unit 114 sets the adjustment threshold value LA based on the second distance L2, the third distance L3, and the competition type. Thus, the appropriate adjustment threshold value LA can be set.

Note that in FIG. 8, a case is described in which the adjustment unit 114 sets the adjustment threshold value LA based on the second distance L2, the third distance L3, and the competition type, but the present disclosure is not limited thereto. The adjustment unit 114 is only required to set the adjustment threshold value LA based on at least one of the second distance L2, the third distance L3, or the competition type.

As described above with reference to FIGS. 1 to 8, the communication system 1 according to the embodiment includes the server device 200, and the first communication device 101 worn by the first player PA competing in the competition CP of moving along the set route, wherein the server device 200 includes the second route storage unit 216 configured to store the route information defining the set route RT and including height information associated with a position on the set route RT, the position acquisition unit 211 configured to acquire the actual measurement position RP being a position actually measured from the first communication device 101, and the position estimation unit 212 configured to estimate a position of the first player PA on the set route RT based on the route information and the actual measurement position RP, and the first communication device 101 includes the estimate position acquisition unit 111 configured to acquire, from the server device 200, the estimate position GP, the estimate position GP being the estimated position of the first player PA, the actual measurement position acquisition unit 112 configured to acquire the actual measurement position RP via the GNSS, the first determination unit 113 configured to determine whether the first distance L1 between the estimate position GP and the actual measurement position RP is greater than or equal to the adjustment threshold value LA, and the first communication instruction unit 116 configured to transmit the actual measurement position RP to the server device 200 when the first determination unit 113 determines that the first distance L1 is greater than or equal to the adjustment threshold value LA.

According to this configuration, when the first distance L1 between the estimate position GP and the actual measurement position RP is greater than or equal to the adjustment threshold value LA, the first communication device 101 transmits the actual measurement position RP to the server device 200. Then, when acquiring the actual measurement position RP, the server device 200 estimates the estimate position GP, which is a position of the first player PA on the route RT, based on the route information and the actual measurement position RP and transmits the estimate position GP to the communication device 100.

Thus, because the communication device 100 transmits the actual measurement position RP to the server device 200 when the first distance L1 between the estimate position GP and the actual measurement position RP is greater than or equal to the adjustment threshold value LA, the frequency of transmitting the actual measurement position RP to the server device 200 can be reduced.

In addition, the estimate position GP is estimated based on the route information including the height information associated with the position on the route RT, and thus the estimate position GP can be appropriately estimated. Thus, the frequency of transmitting the actual measurement position RP to the server device 200 can be reduced.

Further, in the communication system 1, the plurality of communication apparatuses 100 including the first communication device 101 are each worn by the plurality of players P including the first player PA, and the communication device 100 includes the adjustment unit 114 configured to adjust the adjustment threshold value LA in accordance with the second distances L2 between the first player PA and the other players P.

According to this configuration, the adjustment threshold value LA is adjusted in accordance with the second distances L2 between the first player PA and the other players P, and thus the adjustment threshold value LA can be appropriately adjusted. For example, the adjustment threshold value LA is increased as the second distance L2 becomes longer, which can reduce the frequency of transmitting the actual measurement position RP to the server device 200. Further, for example, the adjustment threshold value LA is decreased as the second distance L2 becomes shorter, which allows appropriate estimation of the estimate position GP.

Additionally, in the communication system 1, the competition CP includes the first competition CP1 and the second competition CP2, the communication device 100 includes the second determination unit 115 configured to determine whether the player P is competing in the first competition CP1 or the second competition CP2, and the adjustment unit 114 adjusts the adjustment threshold value LA in accordance with the determination result of the second determination unit 115.

According to this configuration, the adjustment threshold value LA is adjusted in accordance with whether the player P is competing in the first competition CP1 or the second competition CP2, and thus the adjustment threshold value LA can be appropriately adjusted.

For example, when the first competition CP1 is “run” and the second competition CP2 is “bike”, the movement velocity V is faster when the player P is competing in the second competition CP2 than when the player P is competing in the first competition CP1. Thus, the adjustment threshold value LA may be increased when the player P is competing in the second competition CP2 as compared to a case where the player P is competing in the first competition CP1.

Additionally, in the communication system 1, when the third distance L3 between the player P and the competition change position PK, which is a position where the competition CP changes from the first competition CP1 to the second competition CP2, is less than or equal to the distance threshold value LB, the adjustment unit 114 adjusts the adjustment threshold value LA from the first adjustment threshold value LA1 to the second adjustment threshold value LA2 smaller than the first adjustment threshold value LA1.

According to this configuration, when the third distance L3 between the competition change position PK and the player P is less than or equal to the distance threshold value LB, the adjustment unit 114 adjusts the adjustment threshold value LA from the first adjustment threshold value LA1 to the second adjustment threshold value LA2 smaller than the first adjustment threshold value LA1. Thus, the adjustment threshold value LA can be appropriately adjusted.

When the player P is close to the competition change position PK, the player P prepares for change of the competition CP from the first competition CP1 to the second competition CP2. Thus, when the third distance L3 is less than or equal to the distance threshold value LB, the adjustment threshold value LA is adjusted from the first adjustment threshold value LA1 to the second adjustment threshold value LA2. Thus, the adjustment threshold value LA can be appropriately adjusted.

The server device 200 according to the embodiment includes the second route storage unit 216 configured to store the route information defining the set route RT and including height information associated with a position on the set route RT, the position acquisition unit 211 configured to acquire the actual measurement position RP from the first communication device 101 worn by the first player PA competing in the competition CP of moving along the set route RT, the actual measurement position RP being a position actually measured, and the position estimation unit 212 configured to estimate the estimate position GP of the first player PA on the set route RT based on the route information and the actual measurement position RP.

According to this configuration, the estimate position GP of the first player PA on the route RT is estimated based on the route information including the height information associated with the position on the route RT. Thus, the estimate position GP can be appropriately estimated.

The first communication device 101 according to the embodiment is the communication device 100 worn by the first player PA competing in the competition CP of moving along the set route RT in advance, the communication device 100 including the estimate position acquisition unit 111 configured to acquire, from the server device 200, the estimate position GP, the estimate position GP being an estimated position of the player P, the actual measurement position acquisition unit 112 configured to acquire the actual measurement position RP, the actual measurement position RP being a position of the player P actually measured, the first determination unit 113 configured to determine whether the first distance L1 being a distance between the estimate position GP and the actual measurement position RP is greater than or equal to the adjustment threshold value LA, and the first communication instruction unit 116 configured to transmit the actual measurement position RP to the server device 200 when the first determination unit 113 determines that the first distance L1 is greater than or equal to the adjustment threshold value LA.

According to this configuration, when the first distance L1, which is the distance between the estimate position GP and the actual measurement position RP, is greater than or equal to the adjustment threshold value LA, the actual measurement position RP is transmitted to the server device 200, and thus the frequency of transmitting the actual measurement position RP to the server device 200 can be reduced. Furthermore, by setting the adjustment threshold value LA to an appropriate value, the estimation accuracy of the estimate position GP can be maintained in an appropriate range while the frequency of transmitting the actual measurement position RP to the server device 200 can be reduced.

The embodiment is one aspect of the present disclosure and can be optionally varied and applied in the scope of the present disclosure.

Furthermore, each function unit illustrated in FIGS. 2 and 3 indicates a functional configuration, and a specific implementation mode is not particularly limited. In other words, hardware that individually corresponds the functional units is not necessarily implemented, and it is also possible to have a configuration in which a single processor executes a program to implement functions of the plurality of function units. Furthermore, some of the functions implemented by software in the above-described embodiment may be implemented by hardware, or some of the functions implemented by hardware may be implemented by software. In addition, the specific detailed configuration of each of the other units of each of the communication device 100 and the server device 200 can be modified within the spirit of the present disclosure.

The processing units of the flowchart in each of FIGS. 6 and 8 are obtained by dividing the processing in accordance with the main processing contents for easy understanding of the processing of the first control unit 11 and the second control unit 21, and the present disclosure is not limited by how the processing is divided into the processing units or the names of the processing units. The processing may be divided into a larger number of processing units in accordance with the processing contents. The processing may be divided such that one processing unit includes a larger number of processing operations. Furthermore, the order of the processing operations may be appropriately switched in a range that does not hinder the spirit.

The function blocks of the first control unit 11 of the communication device 100 can be implemented by causing the first processor 11A of the first control unit 11 to execute the first control program 117 stored in the first memory 11B. Furthermore, the first control program 117 can also be recorded in a computer-readable recording medium. The recording medium can be a magnetic or optical recording medium, or a semiconductor memory device.

Specific examples include a portable or stationary type recording medium, such as a flexible disk, an HDD, a compact disk read only memory (CD-ROM), a digital versatile disk (DVD), a Blu-ray (trade name) disc, a magneto-optical disc, a flash memory, and a card type recording medium.

In addition, the recording medium may be a non-volatile storage device such as a RAM, a ROM, or an HDD that is an internal storage device included in the communication device 100. Additionally, the first control program 117 can be stored in the server device 200 or the like and downloaded from the server device 200 to the first control unit 11 of the communication device 100 to implement the function blocks of the first control unit 11 of the communication device 100.

The function blocks of the second control unit 21 of the server device 200 can be implemented by causing the second processor 21A of the second control unit 21 to execute the second control program 214 stored in the second memory 21B. Furthermore, the second control program 214 can also be stored in a computer-readable recording medium. The recording medium can be a magnetic or optical recording medium, or a semiconductor memory device.

Specific examples include a portable or stationary type recording medium, such as a flexible disk, an HDD, a CD-ROM, a DVD, a Blu-ray (trade name) disc, a magneto-optical disc, a flash memory, and a card type recording medium.

In addition, the recording medium may be a non-volatile storage device such as a RAM, a ROM, or an HDD that is an internal storage device included in the server device 200. Additionally, the second control program 214 can be stored in another server device or the like and downloaded from the other server device to the second control unit 21 of the server device 200 to implement the function blocks of the second control unit 21 of the server device 200.

What is claimed is:

1. A communication system comprising:
a server device; and
a communication device worn by a player competing in a competition involving moving along a set route, wherein
the server device includes:
a route storage unit configured to store route information defining the set route and including height information associated with a position on the set route,
a position acquisition unit configured to acquire an actual measurement position being a position actually measured from the communication device, and
a position estimation unit configured to estimate a position of the player on the set route based on the route information and the actual measurement position and
the communication device includes:
an estimate position acquisition unit configured to acquire, from the server device, an estimate position being an estimated position of the player,
an actual measurement position acquisition unit configured to acquire the actual measurement position via a global navigation satellite system,
a first determination unit configured to determine whether a first distance between the estimate position and the actual measurement position is greater than or equal to a threshold value, and
a transmission unit configured to transmit the actual measurement position to the server device when the first determination unit determines that the first distance is greater than or equal to the threshold value.

2. The communication system according to claim 1, wherein
a plurality of communication devices including the communication device are each worn by a plurality of players including the player and
the communication device includes an adjustment unit configured to adjust the threshold value in accordance with a second distance between the player and another of the plurality of players.

3. The communication system according to claim 2, wherein
the competition includes a first competition and a second competition,
the communication device includes a second determination unit configured to determine whether the player is competing in the first competition or the second competition, and
the adjustment unit adjusts the threshold value in accordance with a determination result of the second determination unit.

4. The communication system according to claim 3, wherein when a third distance between the player and a position where the competition changes from the first competition to the second competition is less than or equal to a predetermined distance, the adjustment unit adjusts the threshold value from a first threshold value to a second threshold value smaller than the first threshold value.

5. A server device comprising:
a route storage unit configured to store route information defining a set route and including height information associated with a position on the set route;
a position acquisition unit configured to acquire an actual measurement position being a position actually measured from a communication device worn by a player competing in a competition involving moving along the set route; and
a position estimation unit configured to estimate a position of the player on the set route based on the route information and the actual measurement position.

6. A communication device worn by a player competing in a competition involving moving along a set route, the communication device comprising:
an estimate position acquisition unit configured to acquire, from a server device, an estimate position being an estimated position of the player;
an actual measurement position acquisition unit configured to acquire an actual measurement position being a position actually measured of the player;
a determination unit configured to determine whether a first distance between the estimate position and the actual measurement position is greater than or equal to a threshold value; and
a transmission unit configured to transmit the actual measurement position to the server device when the determination unit determines that the first distance is greater than or equal to the threshold value.
